(19) United States
(12) Patent Application Publication
(10) Pub. No.: US 2009/0104983 A1
(43) Pub. Date: Apr. 23, 2009

(54) Game System

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/034,951

(22) Filed: Feb. 21, 2008

Related U.S. Application Data
(60) Provisional application No. 60/981,002, filed on Oct. 18, 2007.

(51) Int. Cl. A63F 13/00

(52) U.S. Cl. 463/27

(57) ABSTRACT

A game system includes plural gaming machine and a common display. Also, the gaming machine has a controller. The controller communicates with other gaming machines so as to make image effects of each of the displays of the plural gaming machines cooperate if any of the gaming machines meets a predetermined condition. Accordingly, entertainment aspects are enhanced, and it allows attracting the players.

### CROSS-REFERENCE TO RELATED APPLICATIONS

This application is based upon and claims a priority from the U.S. Provisional Patent Application No. 60/981,002 filed on Oct. 18, 2007, the entire contents thereof are incorporated herein by reference for all purposes.

### BACKGROUND

1. Field

Game systems related to one or more aspects of present invention have plural gaming machines and a common display, particularly, in the game systems, to attract players, if any of the plural gaming machines meets a predetermined condition, cooperative image effects are made on displays of the plural gaming machines.

2. Description of Related Art

To enhance entertainment aspects, there are gaming machines which make image effects when a predetermined condition is met. Also, to attract players, a gaming machine which has new feature is anticipated.

### SUMMARY

A game system related to one or more aspects of present invention is constructed from plural gaming machines. Also, each of the plural gaming machines has a display and a controller. The controller communicates with other gaming machines so as to make image effects of each display of the plural gaming machines cooperate if any of the plural gaming machines meets a predetermined condition. Accordingly, entertainment aspects are enhanced, and it allows attracting the players.

Also, a game system related to one or more aspects of present invention is constructed from plural gaming machines. Also, each of the plural gaming machines has a display and a controller. The controller performs variably display of symbols on the display and determines whether or not a predetermined condition is met based on the displayed symbols. The controller communicates with other gaming machines so as to make image effects of each display of the plural gaming machines cooperate if any of the plural gaming machines meets a predetermined condition. Accordingly, entertainment aspects are enhanced, and it allows attracting the players.

Also, a game system related to one or more aspects of present invention is constructed from plural gaming machines. Also, each of the plural gaming machines has a display and a controller. The controller performs spinning and stopping of video reels and determines whether or not a predetermined condition is met based on the displayed symbols. The controller communicates with other gaming machines so as to make image effects of each display of the plural gaming machines cooperate if any of the plural gaming machines meets a predetermined condition. Accordingly, entertainment aspects are enhanced, and it allows attracting the players.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

FIG. 1 is a view showing an example of image effects of a main display, an upper display, and a lower display in one embodiment of the present invention.

FIG. 2 is a view showing a construction of a game system in one embodiment of the present invention.

FIG. 3 is a view showing an outline of a slot machine in one embodiment of the present invention.

FIG. 4 is a view showing a control system of the slot machine in one embodiment of the present invention.

FIG. 5 is a view showing a control system of a server in one embodiment of the present invention.

FIG. 6 is a view showing a positional relationship between the slot machines and the main display in one embodiment of the present invention.

FIG. 7 is a flowchart of a main control process in one embodiment of the present invention.

FIG. 8 is a flowchart of a main game process in one embodiment of the present invention.

FIG. 9 is a flowchart of a sever base process in one embodiment of the present invention.

FIG. 10 is an example image display of the main display, the upper display, and the lower display in one embodiment of the present invention in a base game.

FIG. 11 is a view showing a correspondence relationship between jackpots and fish in one embodiment of the present invention.

FIG. 12 a view showing an example of image effects of the main display, the upper display, and the lower display in one embodiment of the present invention.

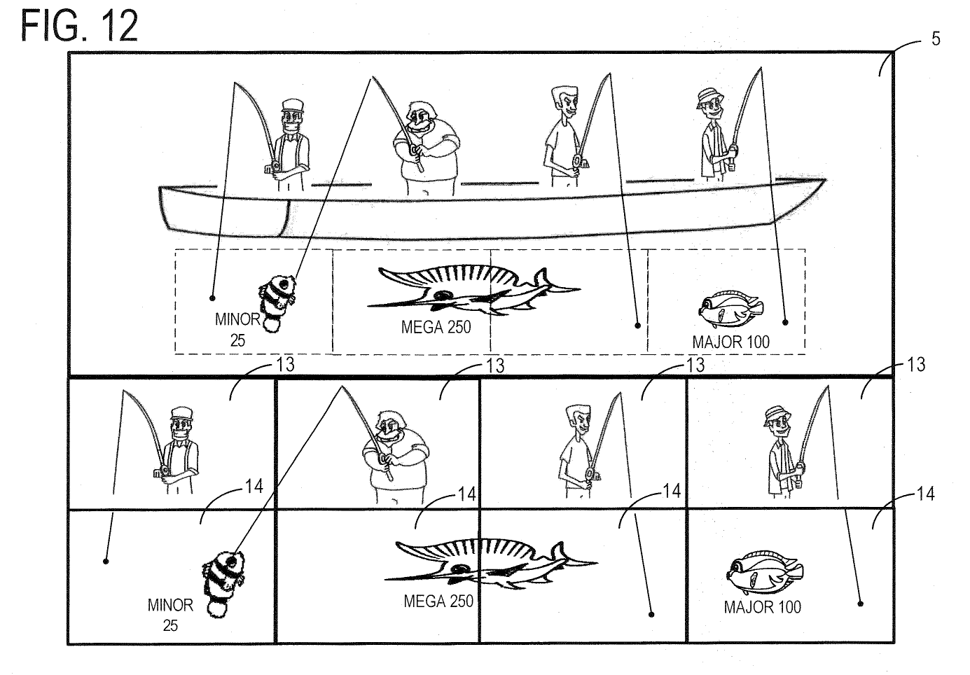

FIG. 13 a view showing an example of image effects of the main display, the upper display, and the lower display in one embodiment of the present invention.

FIG. 14 is a flowchart of a main game process in one embodiment of the present invention.

FIG. 15 a view showing an example of image effects of the main display, the upper display, and the lower display in one embodiment of the present invention.

FIG. 16 a view showing an example of image effects of the main display, the upper display, and the lower display in one embodiment of the present invention.

FIG. 17 a view showing an example of image effects of the upper display and the lower display in one embodiment of the present invention.

FIG. 18 a view showing an example of image effects of the upper display and the lower display in one embodiment of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

### First Embodiment

Hereinafter, a game system related to present invention will be described in detail with reference to the drawings based on a first embodiment embodying a system 3. And, a gaming machine related to the present invention will be described in detail with reference to the drawings based on the first embodiment embodying a slot machine 1.

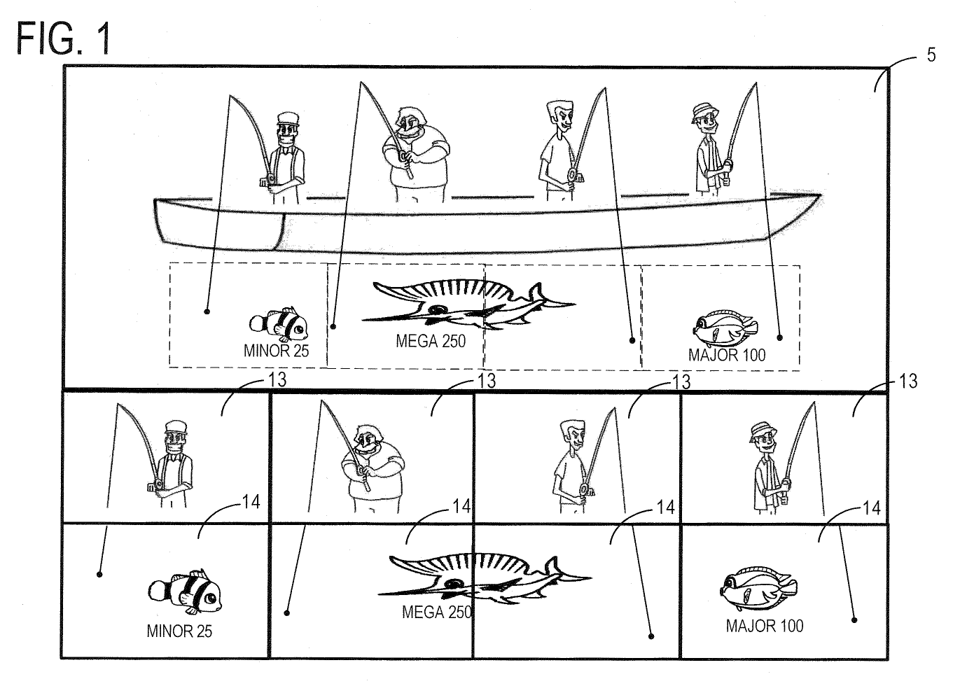

The system 3 related to the embodiment is made up of plural slot machines 1 and a server 2. Each of the slot machines 1 can communicate with other slot machines 1 and cooperative image effects are made on upper displays 13 and lower displays 14 of the plural slot machines 1 (see FIG. 1). Also, a main display 5 is arranged on top of the plural slot machines 1. And, cooperative image effects are made on the upper displays 13 and the lower displays 14 on the plural gaming machines and the main display 5 (see FIG. 1).

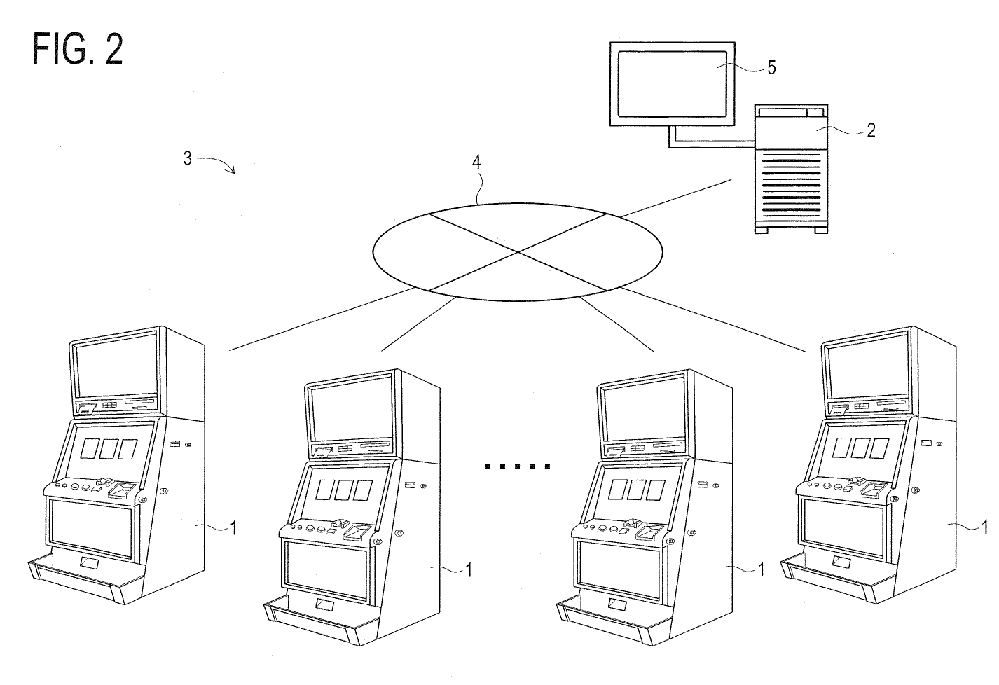

At first, a schematic construction of the system 3 will be described. FIG. 2 is a schematic construction diagram of the system 3 related to the embodiment.

As shown in FIG. 2, the system 3 related to the embodiment is made up of plural slot machines 1 and the server 2. The plural slot machines 1 and the server 2 are arranged inside a gaming hall. Each of the slot machines 1 and the server 2 are interconnected to communicate via a network 4. Also, the slot machine 1 is connected to other slot machines 1 to communicate via the net work 4.

The network 4 is made up of communication line which enables two-way communication. And, the slot machines 1 and the sever 2 send and receive various information related to games via the network 4. For example, when a bet operation is made in the slot machine 1, bet information is sent from the slot machine 1 to the server 2. Here, the bet information includes bet amount and information to identify a slot machine 1 which is bet.

And, the slot machine 1 sends and receives various information related to the games with other slot machines 1 via the network 4. For example, if a bonus trigger of the slot machine 1 is realized, a trigger realizing information is sent to other slot machines 1 and the server 2. Here, the trigger information includes information indicating that the bonus trigger is realized. Also, information to identify the slot machine 1, which the bonus trigger is realized, can be included.

Also, winning notification information indicating a progressive bonus is won is sent from the slot machine 1 in which the bonus trigger is won, to the slot machine 1 in which the progressive bonus is won. Here, the winning notification information also includes information to identify a type of won progressive bonus.

The server 2 has the main display 5. The main display 5 is arranged where all players who play each of the slot machines 1 can look. The server 2 has storage areas for three different jackpots (“MEGA jackpot”, “MAJOR jackpot”, and “MINOR jackpot”). Three fish to indirectly notify jackpot amount of each of the jackpots are displayed on the main display 5 (see FIG. 1). Also, anglers corresponding to each of the slot machines are displayed. Further, plural anglers and a boat on which the plural anglers ride are displayed. Here, display contents image of FIG. 1 is only one example.

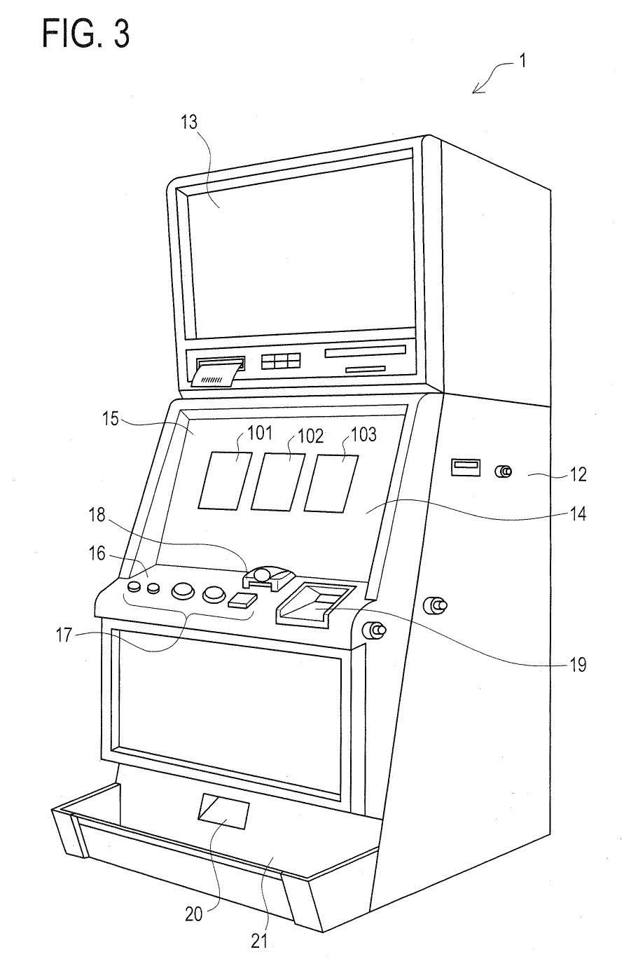

FIG. 3 shows an outline view of the slot machine 1. Each of the slot machines 1 has identification number. This identification number is stored in a predetermined memory medium embedded in the slot machine 1, for example. Also, the server 2 and the slot machines 1 can identify connected slot machines 1 using this identification numbers.

As shown in FIG. 3, the slot machine 1 has a cabinet 12. The slot machines 1 have the upper display 13 and the lower display 14 in front of the cabinet 2 to display various game information. The upper display 13 is arranged on upper side of the cabinet 2. The lower display 14 is arranged on lower side of the cabinet 2.

The upper display 13 is made up of liquid crystal display, for example. The lower display 14 is made up of the liquid crystal display, for example. The lower display 14 has three reel display portions 101 to 103, for example. The base game is executed using the reel display portions 101 to 103. In the base game, variably display and stopped display of symbol rows is performed in each of the reel display portions. Here, the number of symbol rows is variable.

A touch panel 15 is arranged in front of the lower display 14. A player can input various instructions by operating the touch panel 15.

The upper display 13 and the lower display 14 are made up of the liquid crystal display as mentioned, however, the embodiment is not so limited. That is, CRT displays, plasma displays, LED displays, or other known display devices can be used.

And, the slot machine 1 of the embodiment can be hybrid type slot machine made up of mechanical reels and transparent liquid crystal display device arranged in front of the mechanical reels. In this case, symbols displayed on the mechanical reels are visible perceived via the transparent liquid crystal display device. Also, it is preferable that display windows whose number is the same as the number of the mechanical reels is arranged on the transparent liquid crystal display device and it is constructed so that symbols displayed on the mechanical reels are visible perceived via the window displays. Here, in following explanation, slot machines using video reels are mainly described, however, naturally, the present invention is can be applied to slot machines using mechanical reels within applicable limits.

An operation table 16 formed by projecting to proximal side is provided at the bottom of the lower display 14. Various operation buttons 17, such as an exchange button, a payout button, a help button, a bet button, and start button 23 or the like, are arranged on the operation table 16. An arrangement of these buttons is variable. Also, a part of the buttons can be omitted, and new button can be added and replaced, as needed. Also, a coin insertion slot 18 and a bill verifier 22 are arranged on the operation table 16.

Also, a coin payout opening 20 and a coin insertion portion 21 is formed on lower portion of the cabinet 12. The coin payout opening 20 is a portion where coins are paid out based on inputs of the exchange button or the payout button. And, the coin insertion portion 21 is a portion where the coins which are paid out from the coin payout portion 20 are received. A coin detection portion made up of sensor or the like is arranged inside the coin payout opening 20. The coin detection portion detects the number of coins which are paid out from the payout opening 20.

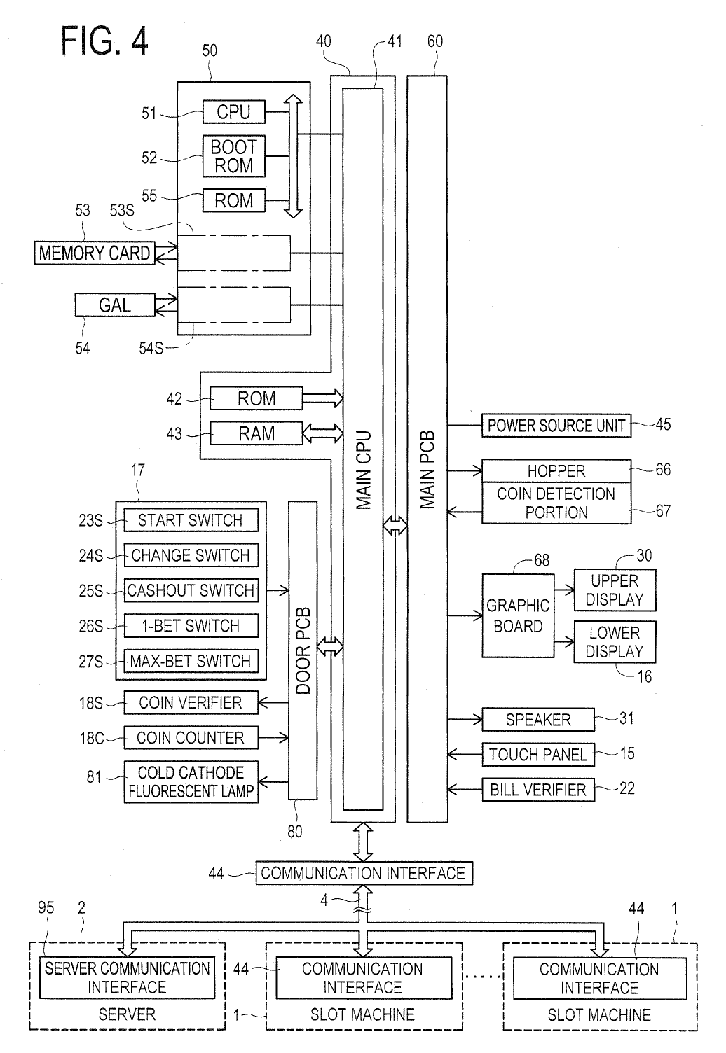

Next, a control system of the slot machine 1 of the embodiment will be described with reference of drawing. FIG. 4 is a block diagram of the control system of the slot machine 1 related to the embodiment.

As shown in FIG. 4, the control system of the slot machine 1 basically includes a mother board 40 and a gaming board 50.

The gaming board 50 includes a CPU 51, a ROM 55, a boot ROM 52, a card slot 53S, and an IC socket 54S which are interconnected via internal bus. A card slot 53S corresponds to the memory card 53. An IC socket 54S corresponds to a GAL (Generic Array Logic) 54.

The memory card 53 is constructed from non-volatile memory and is memory medium in which game programs and game system programs (hereinafter, “the game program and the like”) is stored. The card slot 53S is constructed so that the memory card 53 is detachable, and connected to the mother board 40 via IDE bus, for example. Accordingly, kinds of game and contents can be changed by updating the game program and the like stored in the memory card 53.

Also, the kinds of game and the contents can be changed by exchanging to a memory card 53 in which another game program and the like is stored.

Here, the game program includes image data and sound data or the like, as programs related to game session and image data, sound data, and notification data.

The GAL 54 is one of PLD which contains a fixed OR array construction. The GAL 54 has plural input ports and output ports, and if predetermined data is input to the input ports, the data corresponding thereto will output to the output ports. This output data from the output ports is the payout ratio setting data as described.

The IC socket 54S is constructed so that the GAL 54 is detachable, and connected to the mother board 40 via PCI bus. Accordingly, the payout ratio setting data output from the GAL 54 can be changed by updating the GAL 54 or exchanging the GAL 54 itself.

The CPU 51, the boor ROM, and the ROM 55, which are interconnected via an internal bus, are connected to the mother board 40 via PCI bus. The PCI bus performs signal transfer between the mother board 40 and the gaming board 50. And, it performs electricity supply from the mother board 40 to the gaming board 50. The country identification data and the verification program are stored in the ROM 55. The preliminary verification program and program for the CPU 51 to boot up the preliminary verification program (boot code) or the like are stored in the boot ROM 52.

The verification program is program to verify the game program and the like (falsification check program). The verification program is described according to procedure of falsification check for the game program or the like which is target of verification import process. The preliminary verification program is a program to verify above verification program and described according to procedure of falsification check for the verification program which is target of verification process.

Next, the mother board 40 will be described. The mother board 40 is constructed using commercially general mother board (printed circuit board which mounts basic components of personal computer) and includes the main CPU 41, the ROM 42, the RAM 43, and the communication inter face 44.

The ROM 42 is constructed from a memory device such as the flash memory and program or the like such as BIOS or the like executed in the main CPU 41 is stored. When the BIOS is executed by the CPU 41, initial process for predetermined peripheral device is executed and import process for game programs or the like stored in the memory card 53 is started via the gaming board 50.

Data and programs, which are used when the main CPU 41 runs, are stored in the RAM 43. Also, the verification program which is read via the gaming board 50, various programs such as the game program and the like, various information such as credit number which the player owns or the like can be stored in the RAM 43.

And, the communication interface 44 is a communication device to communicate with the server 2 and other slot machines 1 via the network 4. The slot machine 1 communicates with the server 2 and the slot machines 1 via the communication interface 44.

And, a main PCB (Printed Circuit Board) 60 which will be described later and a door PCB 80 are connected to the mother board 40 respectively via USB. A power source unit 45 is connected to the mother board 40. If the power source unit 45 supplies the electric power to the mother board 40, the main CPU 41 on the mother board 40 will be booted up. Further, the electric power is supplied to the gaming board 50 via PCI bus, and the CPU 51 is booted up.

Equipment and device, which generate the input signal to the main CPU 41, and equipment and device, which operation is controlled by the control signal from the main CPU 41, are connected to the main PCB 60 and the door PCB 80. The main CPU 41 executes the game program and the like stored in the RAM 43 based on the input signal which is input to the main CPU 41. And, by executing predetermined calculation processes, processes for storing calculation result to the RAM 43 and control for each equipment and devices are executed.

A sub CPU 61, a hopper 66, a coin detection portion 67, a graphic board 68, a loudspeaker 31, a touch panel 15, and the bill verifier 22 is connected to the main PCB 60.

The touch panel 15 is arranged in front of the lower display 14, identifies a coordinate of a portion where the player touches, and can recognize where the player touches, further where the player moves based on the coordinate information of the portion touched by the player.

The hopper 66 is arranged inside the cabinet 12, and pays a predetermined number of coins from the coin payout opening 20 to the coin insertion portion 21 based on the control signal from the main CPU 41. A coin detection portion 67 is arranged inside the coin payout opening 20, and if the coin detection portion 67 detects that the coins with the predetermined number is paid out from the coin payout opening 20, the input signal is output to the main CPU 41.

The graphic board 68 controls the display image of the upper display 13 and the lower display 14 based on control signal from the main CPU 41.

And, the graphic board 68 controls the upper display 13 and the lower display 14 based on the control signal from another slot machine 1 in which the bonus trigger is realized in cooperative image effects which will be described later.

Here, the graphic board 68 includes VDP (Video Display Processor) which generates image data based on the control signal and video RAM which temporally stores image data generated by VDP or the like. Image data which is used when image data is generated by VDP is included in the game program.

And, the bill verifier 22 verifies the bill and ticket with barcode, and receives qualified bill and ticket with barcode into the cabinet 12. If verified bill is received, the bill verifies 22 outputs input signal to the CPU 41 based on amount of the bill. And, the input signal is output to the main CPU 41 based on the number of coins stored on the verified ticket with barcode.

On the other hand, the operation button 17, the coin verifier 18S, the coin counter 18C, and a cold cathode fluorescent lamp 81 is connected to the door PCB 80. A start switch 23s corresponding to the start button 23, a change switch 24S corresponding to the change button 24, a cashout switch 25S corresponding to cashout button 25, a 1-bet switch 26S corresponding to the 1-bet button 26, and a max-bet switch 27S corresponding to the max-bet button 27 are arranged on the operation button 17. If the corresponding button is operated by the player, the input signal is output to the main CPU 41.

The coin counter 21C is arranged inside the coin insertion slot 18, and verifies the coins which are input to the coin insertion slot 18 by the player. Things other than verified coins are ejected to the coin payout opening 20, and if verified coins are detected, the input signal is output to the main CPU 41.

The coin verifier 18S performs based on the control signal output from the main CPU 41, and sorts the coins which are recognized as the verified coins by the coin counter 18C into a cash box (not shown) arranged inside the slot machine 1 or the hopper 66. A cold cathode fluorescent lamp 81 is arranged back side of the lower display 14 and an upper display 13, turns on based on the control signal from the main CPU 41, and functions as a back light.

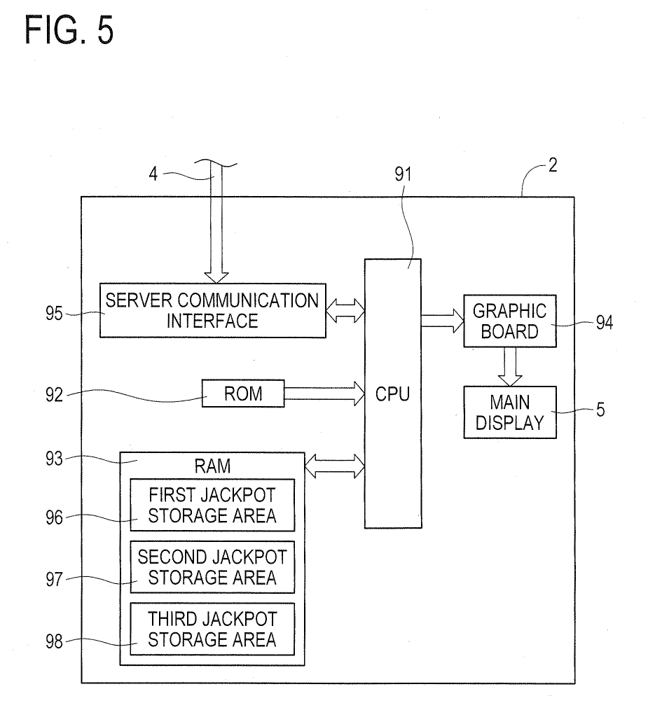

Next, a control system of the server 2 of the embodiment will be described with FIG. 5. FIG. 5 is a block diagram showing the control system of the server 2 according to the first embodiment.

As shown in FIG. 5, the control system of the server 2 includes a CPU 91, a ROM 92, a RAM 93, a graphic board 94, a sever communication interface 95 which are interconnected via internal bus.

The ROM 92 is made up of memory device such as flash memory. Various program and permanent data is stored.

Data and programs used when the CPU 91 runs in stored in the RAM 93. And, the first jackpot storage area 96, the second jackpot storage 97, and the third jackpot storage area 98 are stored in the RAM 93. Jackpot amount of “MEGA jackpot” is stored in the first jackpot storage area 96. Jackpot amount of “MAJOR jackpot” is stored in the second jackpot storage area 97. Jackpot amount of “MEGA jackpot” is stored in the third jackpot storage area 98.

If MEGA progressive bonus is won, credits corresponding to jackpot amount of MEGA jackpot will be provided. If MAJOR progressive bonus is won, credits corresponding to jackpot amount of MAJOR jackpot will be provided. If MINOR progressive bonus is won, credits corresponding to jackpot amount of MINOR jackpot will be provided.

If the CPU 91 receives the bet information from the slot machine 1, jackpot amounts stored in the jackpot storage area 96 to 98 are read, and re-stored after a predetermined portion (for example, 1%) of credits which are bet in the slot machine 1 is added.

The graphic board 94 controls image display on the main display based on the control signal. Concretely, it is controlled as to display fish which indirectly notify jackpot amount of “MEGA jackpot”, “MAJOR jackpot”, and “MINOR jackpot”, plural anglers, and boat on which the plural anglers ride (see FIG. 1).

And, the graphic board 94 controls the main display 5 based on the control signal from the slot machine 1 in which the bonus trigger is realized in cooperative image effects which will be described later.

The graphic board 94 includes VDP (Video Display Processor) which generates image data based on the control signal and video RAM which temporally stores image data generated by VDP or the like. Here, image data which is used when image data is generated by VDP is included in the ROM 92.

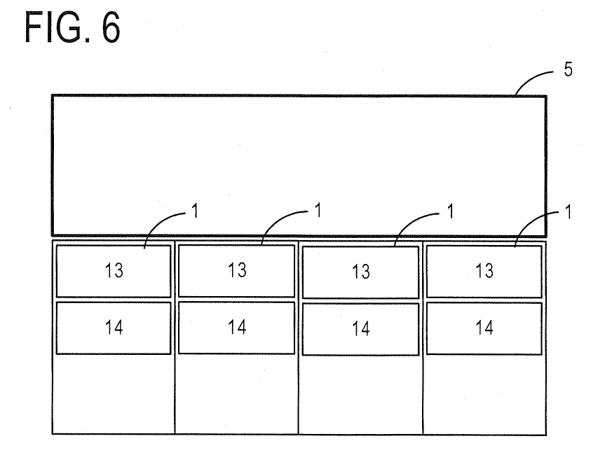

FIG. 6 shows a positional relationship between the plural slot machines 1 and the main display 5. As shown in FIG. 6, one main display 5 is arranged on top of the plural slot machines 1.

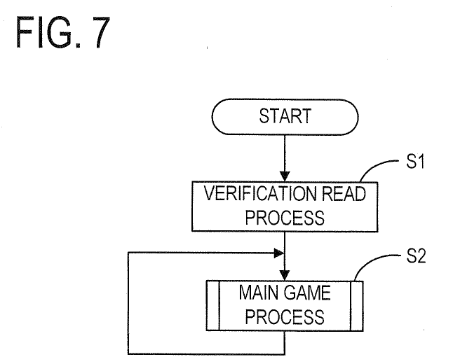

A main control program, which is executed in the slot machine 1 of the embodiment, will be described in detail with reference to the drawing. FIG. 7 is a flowchart of the main control program. Here, concerning the slot machine 1, the memory card 53 is already inserted to the card slot 53S of the gaming board 50, and the GAL 54 is installed to the IC socket 54S.

At first, when the input of the power switch (input of power source) is performed on the power source unit 45, the mother board 40 and the gaming board 50 are booted-up respectively, and the verification read process of S1 is executed. In the verification read process, the mother board 40 and the gaming board 50 execute separately processes in parallel.

In the gaming board 50, the CPU 51 reads the preliminary verification program from the boot ROM 52, and verifies and authenticates that the verification program is not falsified before the verification program is taken to the mother board 40.

On the other hand, in the mother board 40, the main CPU 41 executes BIOS stored in the ROM 42, expands compressed data embedded in BIOS on the RAM 43, executes BIOS expanded on the RAM 43, and performs diagnostic and initialization for various peripheral devices.

After that, the CPU 41 reads the verification program stored in the ROM 55, and certifies to verify and authenticate that the game programs or the like stored in the memory card 53 which is inserted to the card slot 53S. After the verification process is normally ended, the main CPU 41 writes programs or the like which are authentication target (which are authenticated) to the RAM 43, and acquires payout data and country ID.

After above processes is executed, the main CPU 41 finishes the verification read process.

After that, in S2, the main CPU 41 sequentially reads and executes the game program and the like which was verified in the verification real process of S1 from the RAM 43, and executes the main game process. The game according to the first embodiment of the slot machine 1 is executed by executing this main game process. And, the main game process is executed repeatedly during the electronic power source being supplied.

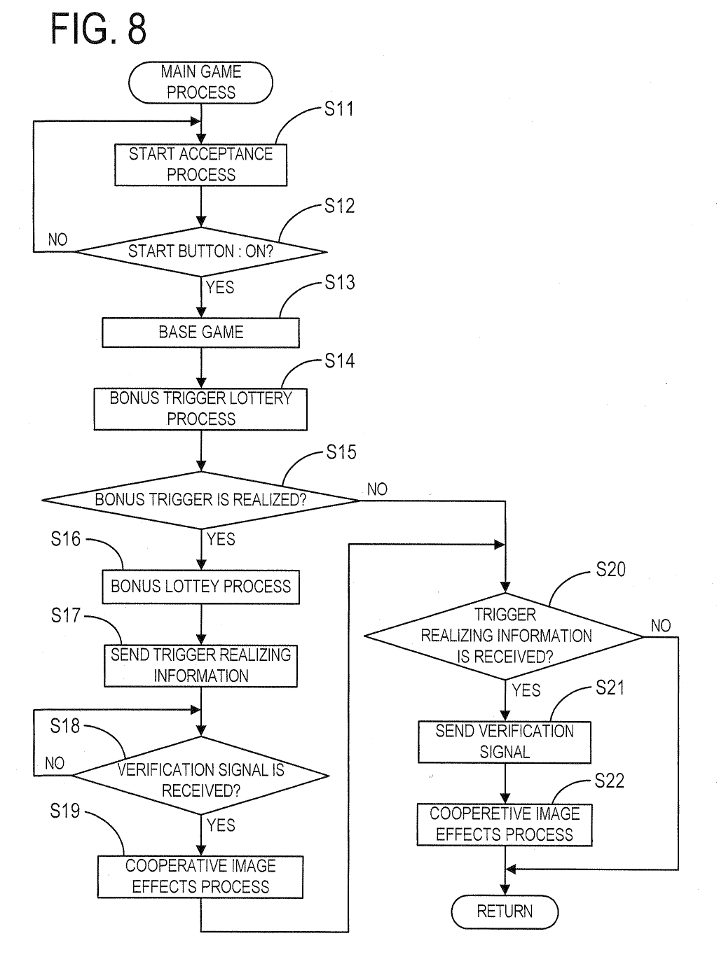

Next, the main game process executed in each of the slot machines 1 will be described with reference to drawing. FIG. 8 is a flowchart of the main game program. Program to execute the flowchart is stored in the ROM 42 and the RAM 43 embedded in the slot machine 1. And, it is executed in the main CPU 41.

In S11, a start acceptance process is executed. In the start acceptance process, after predetermined initial settings are performed, setting for bet count or the like are performed. And, insertions for coins are performed from the coin insertion slot 18 by the player. Also, bet operations using the operation button 17 is performed. The number of coins inserted from the coin insertion slot 18 and bet operation using the operation button 17 are detected.

In S12, it is determined whether or not the start button 23 is operated. It is determined whether or not the start button 23 is operated based on that whether or not the input signal from the start switch 23S is received or not.

If it is determined that the start button 23 is not operated (S12:NO), the procedure will be returned to the start acceptance process again. At this time, operations such as adjustment for bet count or the like is variable can be performed. On the other hand, if it is determined that the start button 23 is operated (S12:YES), the bet count which is set is subtract from credit count in which the player owns, and the bet count is stored in RAM 43 as the bet information. After that, the procedure is shifted to S13.

In S13, the base game is executed. In the base game, for example, after symbol rows are variably displayed in the symbol display portions 101 to 103, stopped and displayed. And, an award is provided based on a combination of stopped symbols. Known various games can be executed as the base game. Also, a predetermined award is provided based on a game result. After that, the procedure will be shifts to S14.

In S14, the bonus trigger lottery process is executed. It is determined by lottery whether or not the bonus trigger is won. At this time, a probability of that the bonus trigger is realized can be set arbitrarily. Also, it can be variable based on the payout ratio or the bet amount. Here, it can be constructed that the bonus trigger lottery process is executed at a predetermined timing.

In S15, it is determined whether or not the bonus trigger is realized. If it is determined that the bonus trigger is realized (S15:YES), the procedure will be shifted to S16. If it is determined that the bonus trigger is not realized (S15:NO), the procedure will be shifted to S20.

In S16, the bonus lottery process is executed. In the bonus lottery process, it is determined by lottery which slot machine 1 wins the progressive bonus among connected slot machines 1. Also, it is determined by lottery which progressive bonus is won among three progressive bonuses.

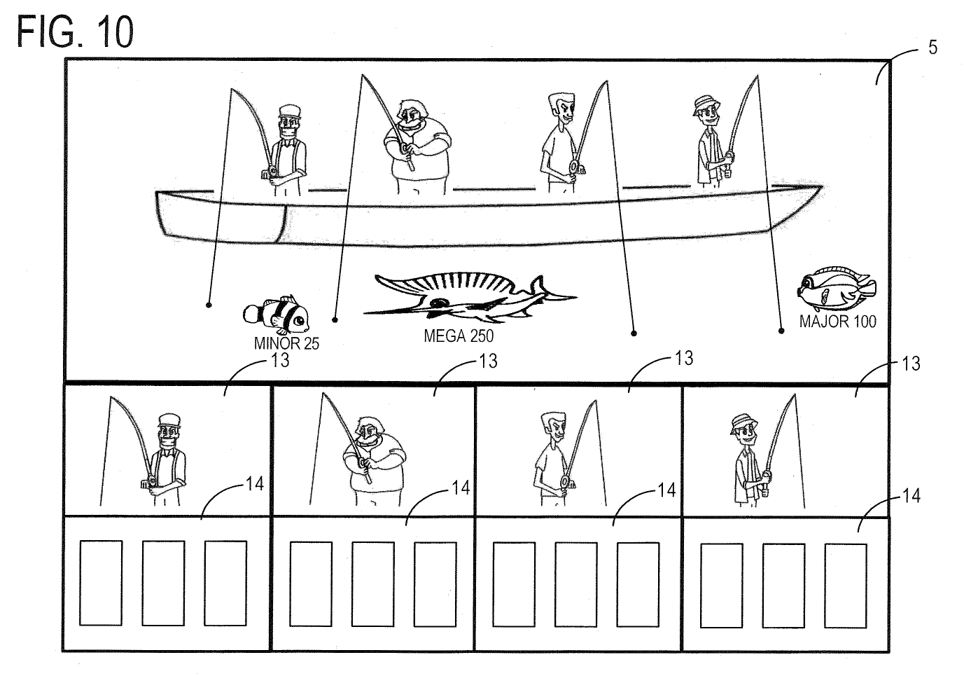

At this time, winning probability of the progressive bonus for each slot machine 1 can be set with equally. At this time, in the example shown in FIG. 10 (namely, four slot machines 1 are connected), each of the winning probability of the progressive bonus of each slot machine 1 is 25%. Also, the winning probability of the progressive bonus of slot machine 1 which the bonus trigger is realized can be set higher. At this time, the winning probability can be set arbitrarily.

In S17, the trigger realizing information, which indicates that the bonus trigger is realized, is sent to the server 2 and other slot machines 1. At this time, an identification signal to identify the slot machine 1 in which the bonus trigger is won can be included.

And, above winning notification signal is also sent to the slot machine 1 which the progressive bonus is won. After that, the procedure will be shifted to S18.

In S18, it is determined whether or not verification signal from the slot machine 1 to which the trigger signal send is received. If it is determined that the verification signals is received from all of the slot machines 1 and the server 2 (S18:YES), the procedure will be shifted to S19. On the other hand, if it is determined that the verification signal is not received from at least one slot machine or the server 2 (S18:NO), the process waits until.

In S19, a process start signal, which indicates to start the cooperative image effects process, is sent to the server 2 and other slot machines 1. After that, the cooperative image effects process is started. Details of the cooperative image effects process will be described later.

In S20, it is determined whether or not the trigger realizing information is received from other slot machines 1. In the flowchart shown in FIG. 8, this process is executed after S19, however, executing timing of this process is can be set arbitrarily.

If it is determined that the trigger realizing information is received (S20:YES), the procedure will be shifted to S21. If it is determined that the trigger realizing information is not received (S20:NO), the main game process will be finished.

In S21, a verification signal, in which indicates that the trigger realizing information is received, is sent to the slot machine 1 which sent the trigger realizing information. After that, the procedure will be shifted to S22. Implementation of the cooperative image effects process of S22 is started based on the process start signal from the slot machine 1 which sent the trigger realizing information. Details of the cooperative image effects process will be described later.

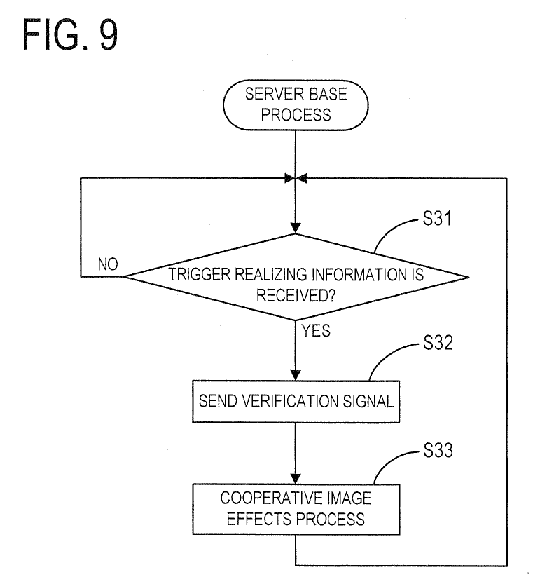

Next, a server base process executed by the server 2 will be described. FIG. 9 is a flowchart of the serve base process. A program to execute the flowchart of FIG. 9 is stored in the ROM 92 and the RAM 93 embedded in the server 2. And, it is executed by the CPU 91.

In S31, it is determined whether or not the trigger realizing information is received from any of the connected slot machines 1. If it is determined that the trigger realizing information is not received (S31:NO), the process waits in S31.

If it is determined that the trigger realizing information is received (S31:YES), the procedure will be shifted to S32. In S32, a verification signal indicating that the trigger realizing information is received is sent to the slot machine 1 which sent the trigger realizing information. After that, the procedure will be shifted to S33. Implementation of the cooperative image effects process of S33 is started based on the process start signal from the slot machine 1 which sent the trigger realizing information.

The cooperative image effects process executed in S19 and S22 of FIG. 8 and S33 of FIG. 9 will be described later. This process can be implemented by slot machine 1 which the bonus trigger is realized and the server 2 performing inter-process communication. This process is mainly executed in the main CPU 41 embedded in the slot machine 1 which the bonus trigger is realized. Concretely, the main CPU 41 controls image effects of the main display 5, the upper display 13, and the lower display 14 by sending predetermined control signals to the graphic board 94 and the graphic board 68.

FIG. 10 is an example of image displays of the main display 5 and the upper display 13 and the lower display 14 of the slot machine 1 in the base game. As shown in FIG. 10, the angler is displayed on the upper display of each of the slot machines 1. Also, symbol display portions are displayed on the lower display 14. Also, plural anglers, fish, and boat are displayed on the main display 5.

Fish displayed on the main display 5 are three different types. Also, around each of fish, jackpot names corresponding thereof and jackpot amount are displayed.

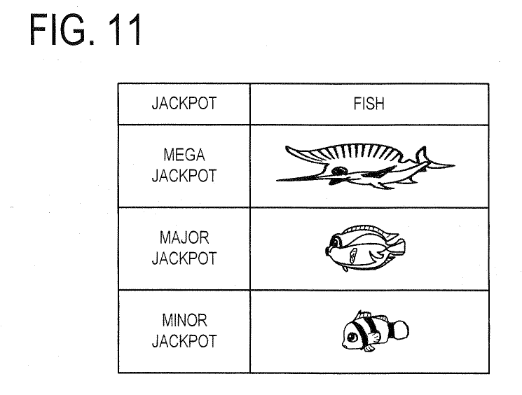

FIG. 11 shows a correspondence relation ship between the jackpots and the fish. Sizes of fish to be displayed on the main display 5 can be changed based on the corresponding jackpot amount.

And, the angler is displayed on the upper display 13 of each of the slot machine 1. The angler to be displayed on the upper display 13 corresponds to the angler to be displayed on the main display 5.

Image effects when the bonus trigger of the slot machine A shown in FIG. 10 is realized and a second slot machine 1 from the left (hereinafter, “slot machine B”) wins MINOR progressive bonus will be described below.

In this case, in S17 of FIG. 8, the slot machine A sends the trigger realizing information which indicates the bonus trigger is realized to the server 2 and other slot machines 1. The other slot machines 1 determine that the trigger realizing information is received in S20 of FIG. 8. Also, the server 2 determines that the trigger realizing information is received in S31 of FIG. 9.

After that, if the slot machine A determines that it is “YES” in S18, the cooperative image effects process will be executed.

Herewith, as shown in FIG. 1, image of the lower display 14 of each slot machine 1 is switched. Concretely, image contents, which are displayed on a part of the main display 5 (shown with dotted line), are displayed on the lower display 14 of the slot machine 1. Herewith, image contents of lower display 14 cooperates with the image contents of the part of the main display 5. And, cooperative images are displayed on each of the lower displays 14 of the slot machines 1.

And, at this time, each of the players can not discriminate which slot machine wins the progressive bonus and which progressive bonus is won.

After that, image effects, which the fish corresponding to MINOR progressive bonus displayed on the lower display 14 of the slot machine A eats bait in which the angler of the upper display 13 of the slot machine B has, is made.

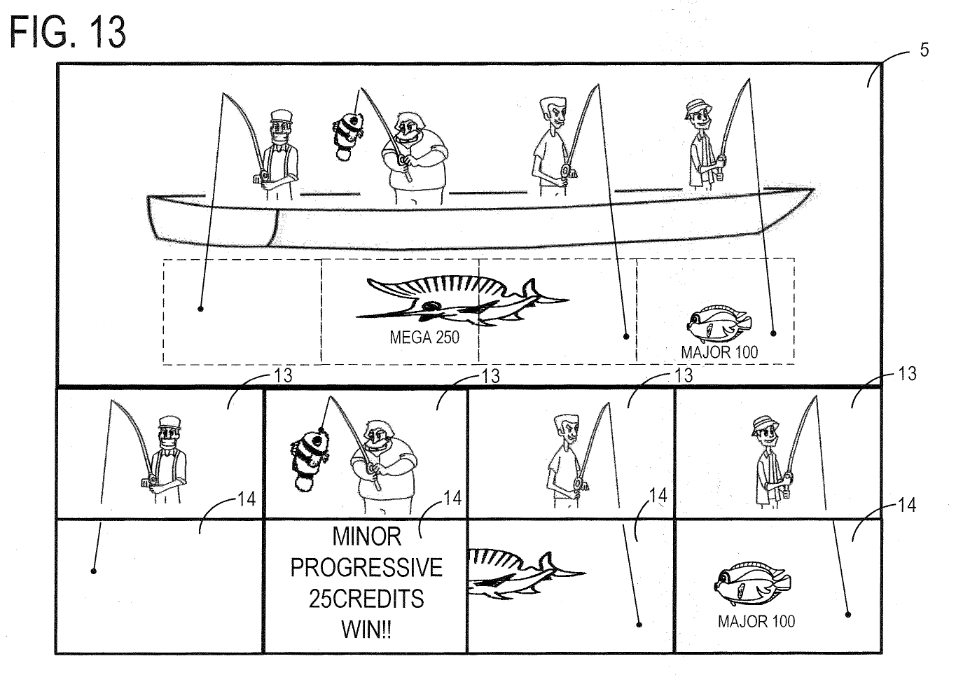

After that, image effects in which the fish is pulled are made on the upper display 13 of the slot machine B (see FIG. 13). Also, information, which indicates that progressive bonus is won, is displayed on the lower display 14 of the slot machine B (see FIG. 13). In FIG. 13, the lower display 14 of the slot machine B notifies that MINOR progressive bonus is won and jackpot amount of MINOR jackpot is 25 credits.

At this time, since the image effects, in which the angler displayed on the upper display 13 of the slot machine B pulls in the fish, are made on the main display 5, other players and onlookers can be notified of that the player of the slot machine B wins the progressive bonus.

And, the jackpot amount of MINOR jackpot (25 credits) is provided in the slot machine B based on received winning notification signal. Also, the jackpot amount of jackpot corresponding to the won progressive bonus is set to initial value.

After the jackpot amount is provided, images of upper display 13 and the lower display 14 of each slot machine 1 is changed to the image display of the base game (see FIG. 10).

As mentioned above, in the embodiment, the slot machine in which the bonus trigger is realized can differ from the slot machine winning the progressive bonus. And, the bonus trigger occurs at random. Since the cooperative image effects process related to the progressive bonus occurs at random, new entertainment aspect can be provided.

### Second Embodiment

In the above first embodiment, the slot machine 1, which the bonus trigger is realized, determines by lottery the slot machine winning the progressive bonus (the bonus lottery process in S16 of FIG. 8). That is, it can occur that the slot machine which the bonus trigger is realized differs from the slot machine winning the progressive bonus. However, the present invention is not limited to this embodiment.

Hereinafter, a second embodiment of the present invention will be described. Since a main control program executed in the slot machine 1 is the same as the main control program of the first embodiment, explanation thereof will be omitted.

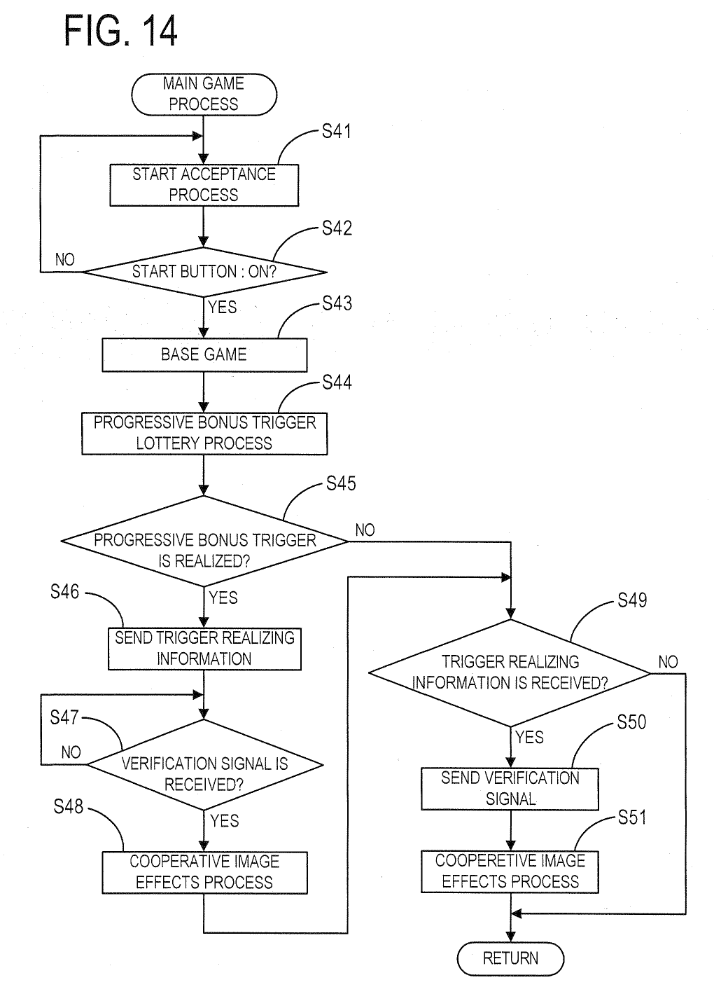

A main game process in the second embodiment will be described with reference to drawings. FIG. 14 is a flowchart of the main game process of the second embodiment. Since processes of S41 to S43 and S47 to S51 are the same as the processes of S11 to S13 and S18 to S22 of FIG. 8 in the first embodiment as described, explanation thereof will be omitted.

In S44, a progressive bonus trigger lottery process is executed. It is determined whether or not the progressive bonus trigger is realized based on lottery. At this time, a probability of that the progressive bonus is realized can be set arbitrarily. Also, it can be variable based on the payout ratio or the bet amount. Here, it can be constructed that the progressive bonus trigger lottery process is executed at a predetermined timing.

Also, if the progressive bonus is realized, it is determined by lottery which progressive bonus is won. At this time, it is determined by lottery which progressive bonus is won among three progressive bonuses (MEGA progressive bonus, MAJOR progressive bonus, or MINOR progressive bonus). After that, the procedure will be shifted to S45.

In S45, it is determined whether or not the progressive bonus trigger is realized. If it is determined that the progressive bonus trigger is realized (S45:YES), the procedure will be shifted to S46. If it is determined that the progressive bonus is not realized (S45:NO), the procedure will be shifted to S49.

In S46, the trigger realizing information indicating that the progressive bonus is realizing is sent to the server 2 and other slot machines 1. In the embodiment, since the slot machine 1 in which the progressive bonus is realized wins the progressive bonus, the bonus lottery process (S16) of FIG. 8 in the first embodiment is not executed.

And, since the server base process of the second embodiment is the same as the server base process of the first embodiment as mentioned (see FIG. 9), an explanation thereof will be omitted.

The cooperative image effects process executed in S48 and S51 of FIG. 14 and S33 of FIG. 9 will be described in detail. This process can be implemented by slot machine 1 which the progressive bonus trigger is realized, the server 2 and other slot machines 1 performing inter-process communication. This process is mainly executed in the main CPU 41 embedded in the slot machine 1 which the progressive bonus trigger is realized. Concretely, the main CPU 41 controls image effects of the main display 5, the upper display 13, and the lower display 14 by sending predetermined control signals to the graphic board 94 and the graphic board 68.

Since image displays in the base games are the same as the image displays shown in FIG. 10, explanation thereof will be omitted.

Image effects when the progressive bonus trigger of the slot machine A shown in FIG. 10 is realized and MINOR progressive bonus is won will be described below.

In this case, in S46 of FIG. 14, the slot machine A sends the trigger realizing information, which indicates the progressive bonus trigger is realized, to the server 2 and other slot machines 1. The other slot machines 1 determine that the trigger signal is received in S49 of FIG. 14. And, the server 2 determines that the trigger realizing information is received in S31 of FIG. 9.

After that, if the slot machine A determines that it is “YES” is S47, the cooperative image effects process will be started.

Herewith, as shown in FIG. 1, image of the lower display 14 of each slot machine 1 is switched. Concretely, image contents, which are displayed on a part of the main display 5 (shown with dotted line), are displayed on the lower display 14 of the slot machine 1. Herewith, image contents of lower display 14 cooperates with the image contents of the part of the main display 5. Also, cooperative images are displayed on the lower displays 14 of each slot machine 1.

And, at this time, each of the players can not discriminate which slot machine wins the progressive bonus and which progressive bonus is won.

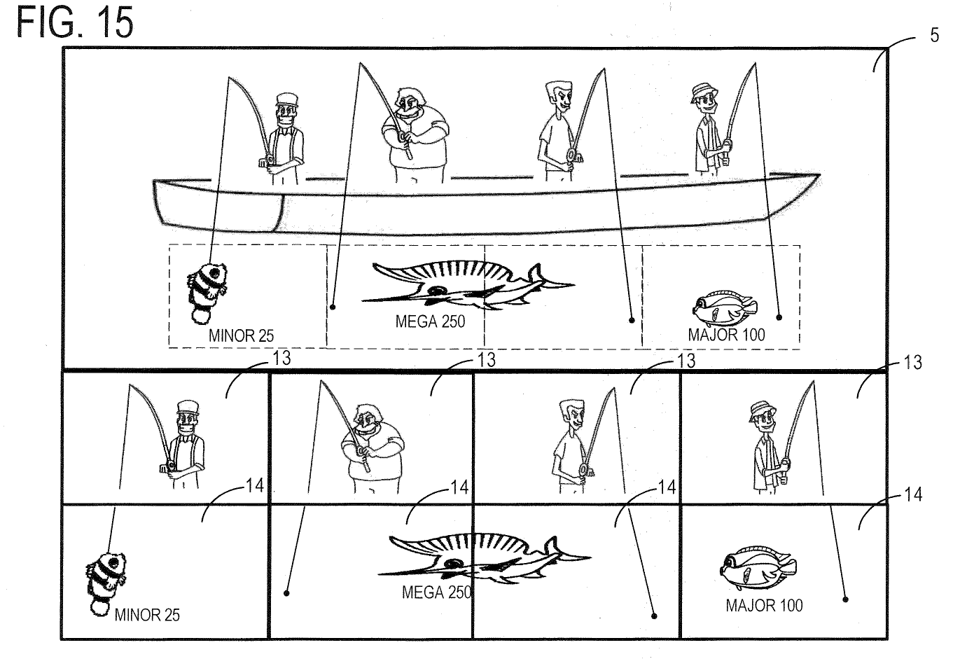

After that, image effects, which the fish corresponding to MINOR progressive bonus displayed on the lower display 14 of the slot machine A eats bait in which the angler of the upper display 13 of the slot machine A has, is made (see FIG. 15).

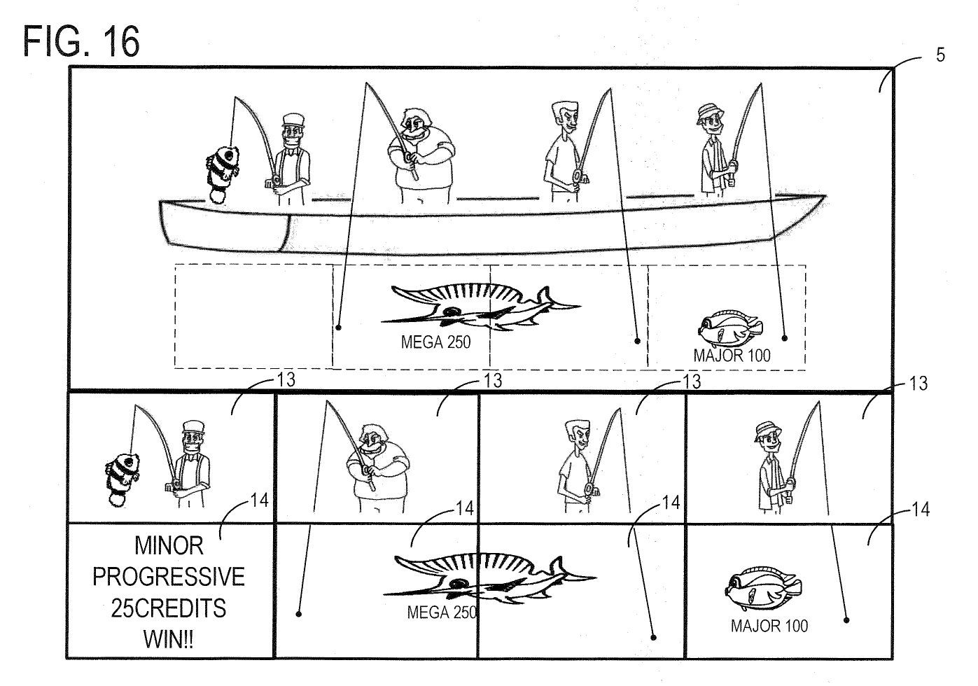

After that, image effects in which the fish is pulled in are made on the upper display 13 of the slot machine A (see FIG. 16). Also, information, which indicates that progressive bonus is won, is displayed on the lower display 14 of the slot machine A (see FIG. 16). In FIG. 16, the lower display 14 of the slot machine A notifies that MINOR progressive bonus is won and jackpot amount of MINOR jackpot is 25 credits.

At this time, since the image effects, in which the angler displayed on the upper display 13 of the slot machine A pulls in the fish, are made on the main display 5, other players and onlookers can be notified of that the player of the slot machine A wins the progressive bonus.

And, the jackpot amount of MINOR jackpot (25 credits) is provided in the slot machine A based on received winning notification signal. Also, the jackpot amount of jackpot corresponding to the won progressive bonus is set to initial value.

After the jackpot amount is provided, images of upper display 13 and the lower display 14 of each slot machine 1 is changed to the image display of the base game (see FIG. 10).

As mentioned above, in the second embodiment, if the slot machine 1 wins the progressive bonus, image effects corresponding to this winning is made on displays of won slot machine 1 in conjunction with displays of other slot machines 1 and the main display 5. And, the progressive bonus trigger occurs at random. Accordingly, since the cooperative image effects process (the cooperative image process) related to the progressive bonus occurs at random, new entertainment aspect can be provided.

The present invention is not limited to above embodiments and various changes and modifications can be done within the scope of the present invention certainly.

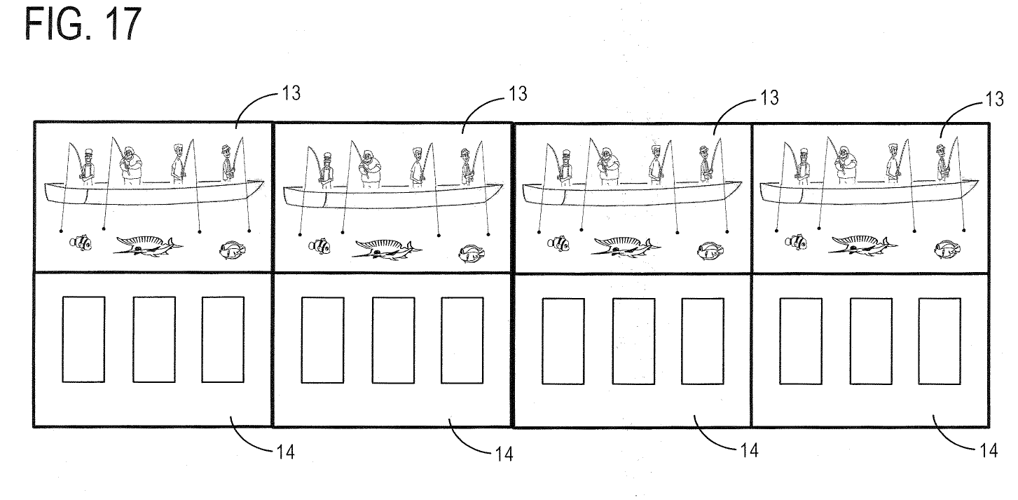

For example, in the above embodiments, the main display 5 is arranged, however, the present invention can be constructed plural gaming machines 1 without the main display. In this case, image contents displayed on the main display shown in FIG. 10 will be displayed on each of the upper displays 13 in the base game (see FIG. 17).

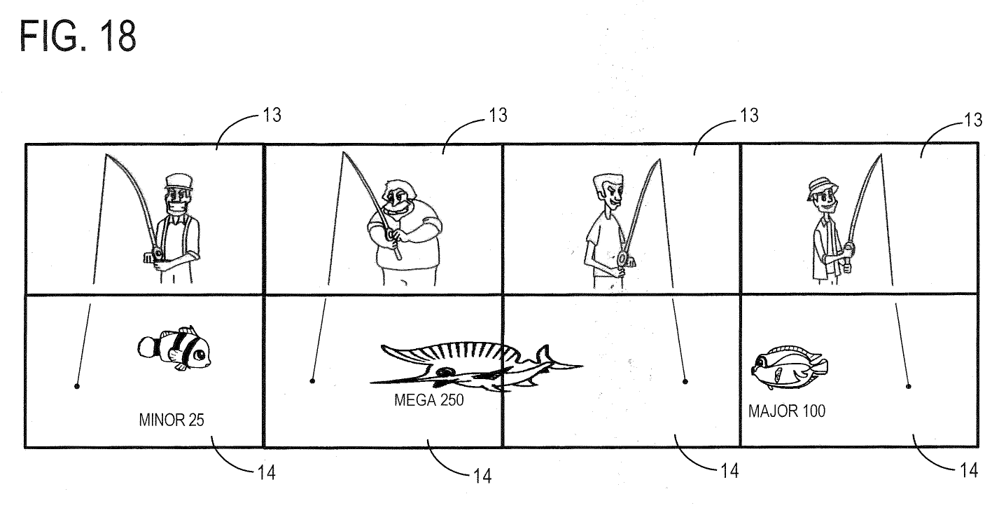

And, if the bonus trigger is realized in any of the slot machines 1, image contents displayed on the upper display 13 and the lower display 14 described in FIG. 10 will be displayed on each of the upper displays 13 in the base game (see FIG. 18).

Also, the present invention is applied to card game machines. In this case, for example, in card game machine performing poker game or the like, if a predetermined condition is met, it can be constructed that the cooperative image effects process is executed.

Also, the present invention can be implemented as a playing method to execute above processes. Further, the present invention can be implemented as a program to execute above processes in one or more computers, and a tangible medium in which the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A game system comprising:
plural gaming machines, each of the plural gaming machines having a display and a controller, wherein
the controller communicates with other gaming machines so as to make image effects of each of the displays of the plural gaming machines cooperate if any of the gaming machines meets a predetermined condition.

2. The game system according to claim 1, wherein predetermined one of the controllers determines a gaming machine which an award will be provided by lottery if any of the plural gaming machines meets a predetermined condition, and
the award is provided to the determined gaming machine.

3. The gaming system according to claim 2, wherein
the award is a progressive bonus, and
an image corresponding to jackpot amount of the progressive bonus is displayed on predetermined the display.

4. A game system comprising:
plural gaming machines, each of the plural gaming machines having a display and a controller, wherein
the display displays plural symbols, and
the controller
(a) receives a start of a unit game,
(b) variably displays the plural symbols in response to receiving start of the unit game,
(c) displays the plural symbols on the display as a game result of the unit game,
(d) determines whether or not a predetermined condition is met based on symbols displayed on the display, and
(e) communicates with other gaming machines so as to make image effects of each of the displays of the plural gaming machines cooperate if any of the gaming machines meets a predetermined condition.

5. The game system according to claim 4, wherein
predetermined one of the controllers determines a gaming machine which an award will be provided by lottery if any of the plural gaming machines meets a predetermined condition, and
the award is provided to the determined gaming machine.

6. The gaming system according to claim 5, wherein
the award is a progressive bonus, and
an image corresponding to jackpot amount of the progressive bonus is displayed on predetermined the display.

7. A game system comprising:
plural gaming machines, each of the plural gaming machines having a display and a controller, wherein
the display displays plural video reels and plural symbols displayed on the video reels, and
the controller
(a) receives a start of a unit game,
(b) performs spinning and stopping of the plural video reels in response to receiving the start of the unit game,
(c) displays the plural symbols on the display as a game result of the unit game,
(d) determines whether or not a predetermined condition is met based on symbols displayed on the display, and
(e) communicates with other gaming machines so as to make image effects of each of the displays of the plural gaming machines cooperate if any of the gaming machines meets a predetermined condition.

8. The game system according to claim 7, wherein
predetermined one of the controllers determines a gaming machine which an award will be provided by lottery if any of the plural gaming machines meets a predetermined condition, and
the award is provided to the determined gaming machine.

9. The gaming system according to claim 8, wherein
the award is a progressive bonus, and
an image corresponding to jackpot amount of the progressive bonus is displayed on predetermined the display.
